(19) United States
(12) Patent Application Publication
(10) Pub. No.: US 2019/0176974 A1
(43) Pub. Date: Jun. 13, 2019

(54) UNMANNED AERIAL VEHICLE

(71) Applicant: PRODRONE CO., LTD., Nagoya-shi, Aichi (JP)

(72) Inventor: Kiyokazu SUGAKI, Nagoya-shi (JP)

(73) Assignee: PRODRONE CO., LTD., Nagoya-shi, Aichi (JP)

(21) Appl. No.: 16/327,040

(22) PCT Filed: Sep. 2, 2016
(86) PCT No.: PCT/JP2016/075751

§ 371 Date: Feb. 21, 2019

(51) Int. Cl. B64C 25/54; B64C 39/02

(52) U.S. Cl. CPC B64C 25/54; B64C 39/024

(57) ABSTRACT

An unmanned aerial vehicle is capable of keeping the airframe level on the water surface and is capable of taking off from and landing on water smoothly. The problem is solved by an unmanned aerial vehicle that includes: a plurality of rotary wings; and a plurality of arms radially extending from an airframe center portion of the unmanned aerial vehicle. The arms include floating portions extending downward from the respective arms. The floating portions include air chambers in the respective floating portions, the air chambers each including a hollow and hermetic space.

### TECHNICAL FIELD

The present invention relates to a water take-off and landing technique of an unmanned aerial vehicle.

### BACKGROUND ART

Conventional small-size unmanned aerial vehicles represented by industrial unmanned helicopters have had airframes too expensive to be affordable. Also, these vehicles used to require skillful pilotage for stable flight. In recent years, however, there have been considerable improvements in sensors and software used to control posture of unmanned aerial vehicles and to implement autonomous flight of unmanned aerial vehicles. This has led to considerable improvement in manipulability of unmanned aerial vehicles and availability of high-end airframes at lower prices. Under the circumstances, multi-copters, especially small size multi-copters, are currently not only used for hobbyist purposes but also applied to various missions in a wide range of fields, since multi-copters are simpler in rotor structure than helicopters and thus easier to design and maintain. In order to further enlarge the applicable range of multi-copters, there has been a need for a multi-copter with a structure that enables the multi-copter to take off from and land on water.

### CITATION LIST

### Patent Literature

PTL1: JP 11-334698 A

### SUMMARY OF INVENTION

### Technical Problem

Realizing a multi-copter capable of taking off from and landing on water naturally involves increasing the waterproof property of the airframe itself of the multi-copter. If, however, the airframe tilts after landing on water and part of a rotor sinks in water, it is difficult for the airframe to take off from water. In light of the above circumstances, in order to make the multi-copter take off from water without human intervention after landing on water, it is necessary to keep the airframe level on the water surface.

Also, with an airframe such as the one recited in, for example, patent literature 1, there is such a problem that a buoyant structure mounted on the bottom surface of the airframe becomes attached to the water surface, making it difficult for the airframe to take off from water smoothly.

An object of the present invention is to overcome the above-described problem in the background art and to provide an unmanned aerial vehicle that is capable of keeping the airframe level on the water surface and that is capable of taking off from and landing on water smoothly.

### Solution to Problem

In order to solve the above-described problem, an unmanned aerial vehicle according to the present invention includes: a plurality of rotary wings; and a plurality of arms radially extending from an airframe center portion of the unmanned aerial vehicle. The arms include floating portions extending downward from the respective arms. The floating portions include air chambers in the respective floating portions, the air chambers each including a hollow and hermetic space.

Also, each floating portion of the floating portions may preferably have a tapering shape having an outer diameter that gradually decreases toward a lower end of the each floating portion.

Also, the each floating portion may have an vertically long shape, and the each floating portion may have the tapering shape at a lower side in a vertical direction of the each floating portion.

Also, the floating portions may preferably be located at leadings end of the respective arms, which include the respective floating portions, and the rotary wings may be located above the respective floating portions.

Also, each air chamber of the air chambers of the floating portions may include an air valve, and the air valve may preferably be configured to keep pressure in the each air chamber within a predetermined range by: releasing air out of the each air chamber when the pressure in the each air chamber has increased and exceeded a predetermined threshold; and taking the air into the each air chamber when the pressure in the each air chamber has decreased and fallen below a predetermined threshold.

Also, each floating portion of the floating portions further may include a leg storage chamber that includes a space vertically extending along a center in a radial direction of the each floating portion. The leg storage chamber may be partitioned from the air chamber and extends downward through the each floating portion. The leg storage chamber may contain an elastic member and a bar-shaped member energized downward by the elastic member. The bar-shaped member may have a lower end portion exposed downward through the leg storage chamber.

Also, the plurality of arms may include three or more arms circumferentially arranged at equal intervals around the airframe center portion.

### Advantageous Effects of Invention

The unmanned aerial vehicle according to the present invention is capable of keeping the airframe level on the water surface and capable of taking off from and landing on water smoothly.

### BRIEF DESCRIPTION OF DRAWINGS

FIG. 1 is a perspective view of an exterior of a multi-copter according to this embodiment.

FIG. 2 is an enlarged view of a float.

FIG. 3 is a cross-sectional view taken along B-B illustrated in FIG. 2.

FIG. 4 is a block diagram illustrating a functional configuration of the multi-copter.

FIG. 5 is a side sectional view of a modification of the float.

### DESCRIPTION OF EMBODIMENTS

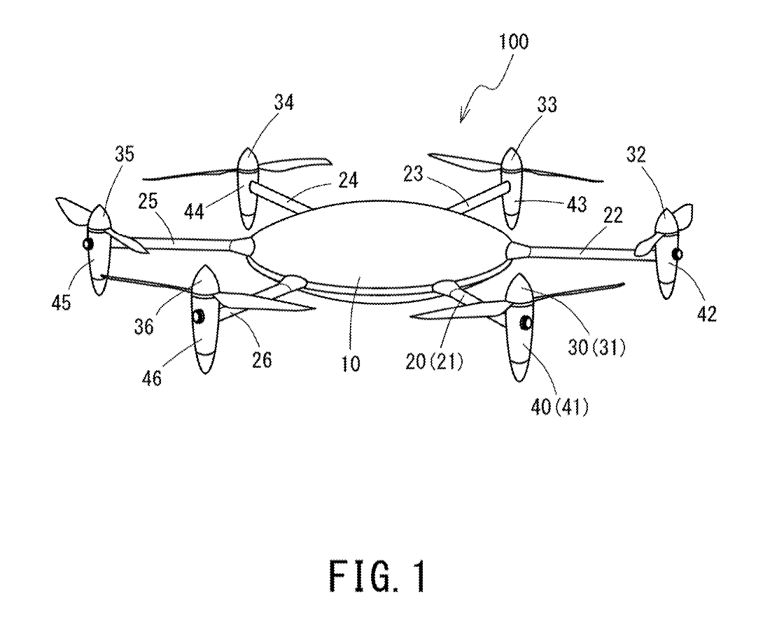

An embodiment of the present invention will be described by referring to the accompanying drawings. The following embodiment is an example of a multi-copter, which is a kind of an unmanned aerial vehicle having a plurality of rotary wings. It is to be noted that in the following description and the present invention, the terms “up” and “down” refer to vertical directions as seen in FIG. 1.

[Outline of Configuration]

FIG. 1 is a perspective view of an exterior of a multi-copter 100 according to this embodiment. As illustrated in FIG. 1, the multi-copter 100 includes six arms 21 to 26, which extend horizontally from an airframe center portion 10 of the multi-copter 100 (these arms will be hereinafter collectively referred to as “arms 20”). The arms 20 are circumferentially arranged at equal intervals around the airframe center portion 10 and extend radially from the airframe center portion 10.

At the leading ends of the arms 20, floats 41 to 46 are located. The floats 41 to 46 are floating portions extending downward from the respective arms 20 (these floats will be hereinafter collectively referred to as “floats 40”). Above the floats 40, rotors 31 to 36 are located. The rotors 31 to 36 are rotary wings (these rotors will be hereinafter collectively referred to as “rotors 30”).

[Float Structure]

Each float 40 of the floats 40 has an air chamber 51 (described later) in the each float 40. The air chamber 51 is a hollow and hermetic space. By having the air chamber 51, the each float 40 serves as a floating member that makes the multi-copter 100 float on water surfaces. The floats 40 are mounted on the arms 20, which support the respective rotors 30. This prevents the rotors 30 on the arms 20 from sinking in water when the multi-copter 100 has landed on water.

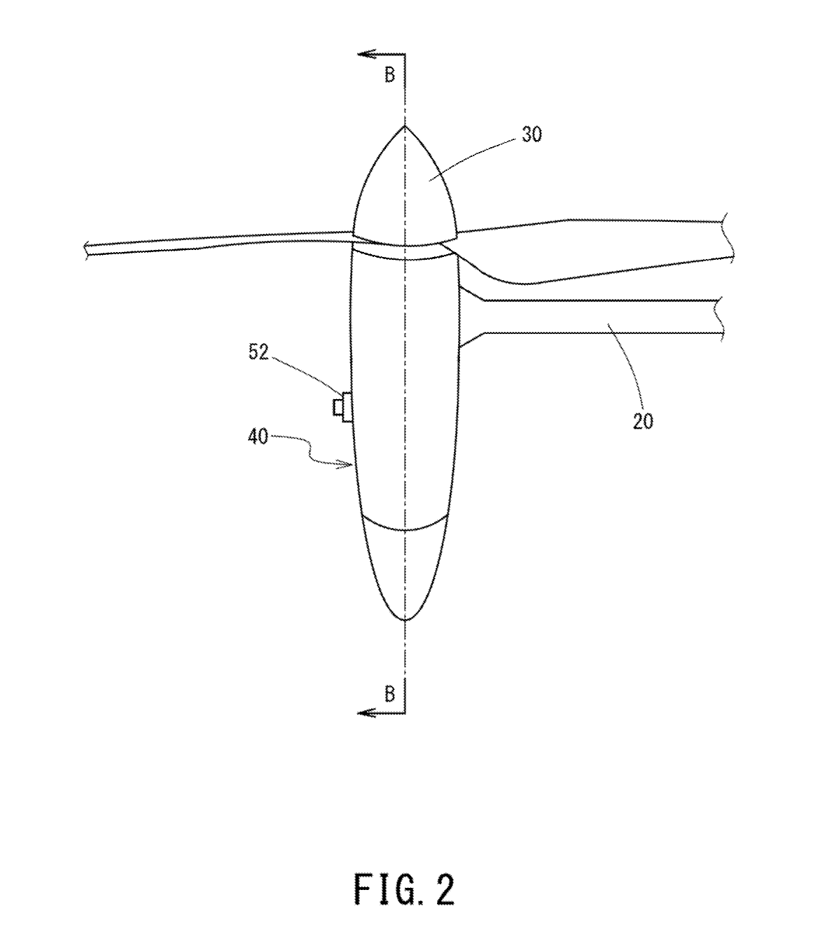

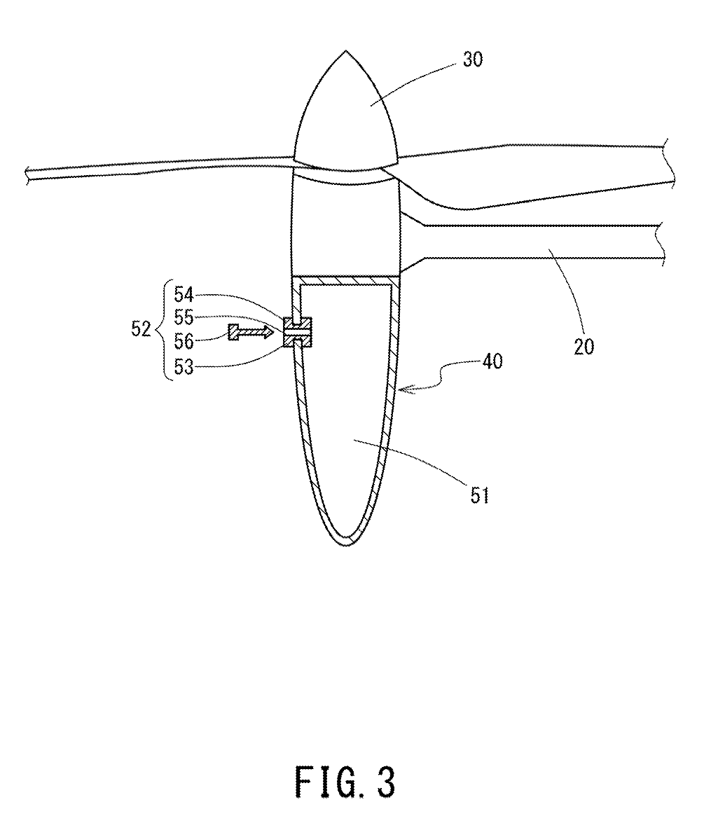

FIG. 2 is an enlarged view of the each float 40, and FIG. 3 is a cross-sectional view taken along B-B illustrated in FIG. 2. As illustrated in FIGS. 1 through 3, the float 40 has an vertically long shape. The float 40 has an approximately hollow-cylindrical shape that extends upward from a center portion of the float 40 in its vertical direction, and has a tapering shape that extends downward from the center portion and that gradually decreases in outer diameter toward the lower end of the float 40. The tapering shape of the float 40 is less resistant to the water surface when the float 40 lands on water perpendicularly to the water surface. The tapering shape also makes it difficult for the water surface to attach to the float 40 when the float 40 takes off from water.

The airframe center portion 10 according to this embodiment is approximately disk-shaped. The floats 40 protrude further downward than the bottom surface of the airframe center portion 10. With this configuration, the floats 40 double as skids (legs) of the multi-copter 100. With the floats 40 doubling as skids, the multi-copter 100 has a simplified airframe structure.

When the multi-copter 100 lands on water, it is preferable that the bottom surface of the airframe center portion 10 be out of contact with the water surface. This is for the purpose of preventing the water surface from attaching to the airframe center portion 10, thereby minimizing the resistance against the multi-copter 100 when taking off from water. The floats 40 protrude further downward than the bottom surface of the airframe center portion 10. This enables the floats 40 to keep the airframe center portion 10 out of contact with the water surface by adjusting the buoyancy of the floats 40, the number of floats 40 to be installed, the lengths of the floats 40, and other parameters in a desired manner. The floats 40 according to this embodiment have such a configuration that prevents the airframe center portion 10 from landing on water. This configuration enables the multi-copter 100 to take off from and land on water smoothly.

As described earlier, the arms 20 according to this embodiment are circumferentially arranged at equal intervals around the airframe center portion 10, and the floats 40 are located at the leading ends of the respective arms 20. That is, the floats 40 according to this embodiment are located at positions farthest away from the airframe center portion 10, and, further, located at positions to which the weight of the airframe center portion 10 can be uniformly dispersed. This enables the multi-copter 100 to stably keep the airframe level on water surfaces.

Also, the floats 40 extend downward from the rotors 30. Typically, the rotors 30 are located at positions at which the rotors 30 are able to more easily keep the airframe in balance in the air. The floats 40 are located at positions identical to the positions of the respective rotors 30. This enables the multi-copter 100 to keep the airframe sufficiently level not only in the air but also on water surfaces.

As illustrated in FIG. 3, the air chamber 51, which is a hollow and hermetic space, is located inside the float 40. Further, an air valve 52 is mounted on the air chamber 51 of the float 40. The air valve 52 according to this embodiment is made up of: a gasket 54, which is fitted with an attachment hole 53 of the air chamber 51; and a pin 56, which is mounted in a through hole 55 of the gasket by being inserted through the through hole 55. It is to be noted that the gasket 54 and the pin 56 are made of a rubber material, a plastic material, or another material. At normal time, the air valve 52 is sealed, with the pin 56 in the gasket 54. This prevents water from entering the air chamber 51 through the air valve 52 when the multi-copter 100 lands on water.

The air valve 52 is a mechanism that avoids damage to the float 40 when the air in the air chamber 51 expands or contracts. More specifically, the air valve 52 keeps the pressure in the air chamber 51 within a predetermined range by: releasing the air out of the air chamber 51 when the pressure in the air chamber 51 has increased and exceeded a predetermined threshold; and taking air into the air chamber 51 when the pressure in the air chamber 51 has decreased and fallen below a predetermined threshold. It is to be noted that the thresholds vary depending on the material of the gasket 54, the size and shape of the pin 56, and/or other characteristics. By changing these characteristics suitably, the thresholds are adjusted to optimum values for this embodiment.

[Modification of Float]

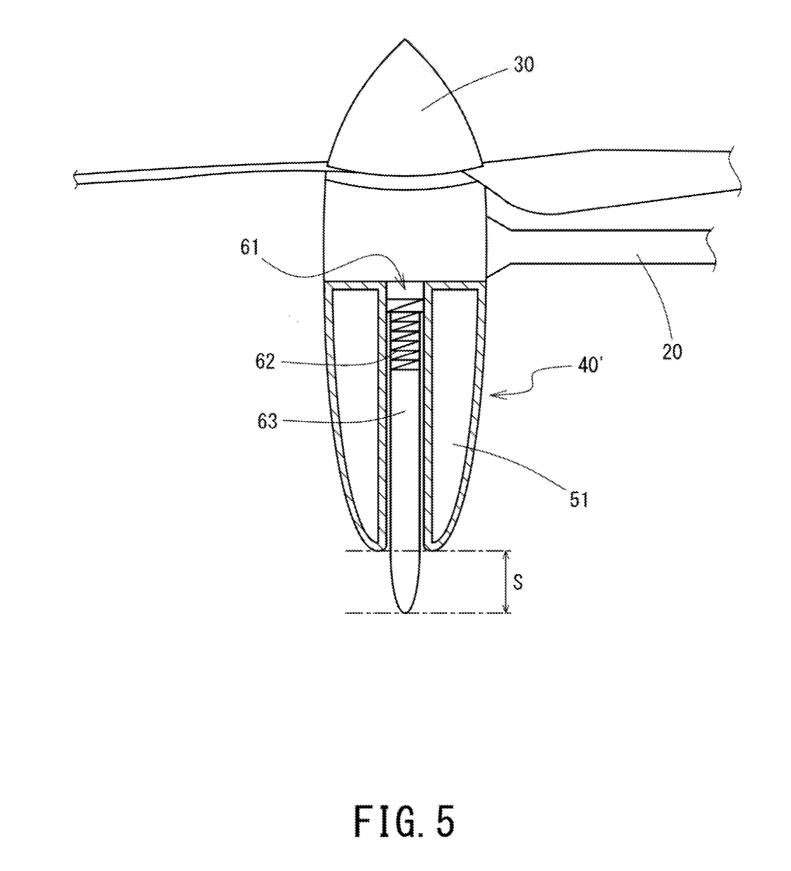

FIG. 5 is a side sectional view of a structure of a float 40′, which is a modification of the float 40. The float 40′ has such a configuration that the skid function of the float 40 is expanded. It is to be noted that in the following description, configurations serving same or similar functions in the float 40′ and the float 40 will be denoted the same reference numerals, and these configurations will not be elaborated upon here.

The float 40′ includes a leg storage chamber 61, which is a space vertically extending along the center in the radial direction of the float 40′. The leg storage chamber 61 is partitioned from the air chamber 51 and vertically extends through the float 40′. The leg storage chamber 61 contains: a coil spring 62, which is an elastic member; and a leg 63, which is a bar-shaped member energized downward by the coil spring 62. The leg 63 has a lower end portion and a portion near the lower end portion. These portions are exposed downward through the leg storage chamber 61. The leg 63 is supported by the elasticity force of the coil spring 62. This enables the exposed portions of the leg 63 to be exposed or hidden within the range indicated by arrow S illustrated.

If the multi-copter 100 lands on the ground with the floats 40 directly contacting the ground, the floats 40 may be damaged when the weight of the airframe is a particular weight, when the descending speed of the airframe is a particular descending speed, and/or when the hardness of the ground is a particular hardness. In this modification, the multi-copter 100 lands on the leg 63, which is cushioned by the coil spring 62. This alleviates the landing impact on the float 40′, eliminating or minimizing the damage to the float 40′.

[The Rest of Airframe Configuration]

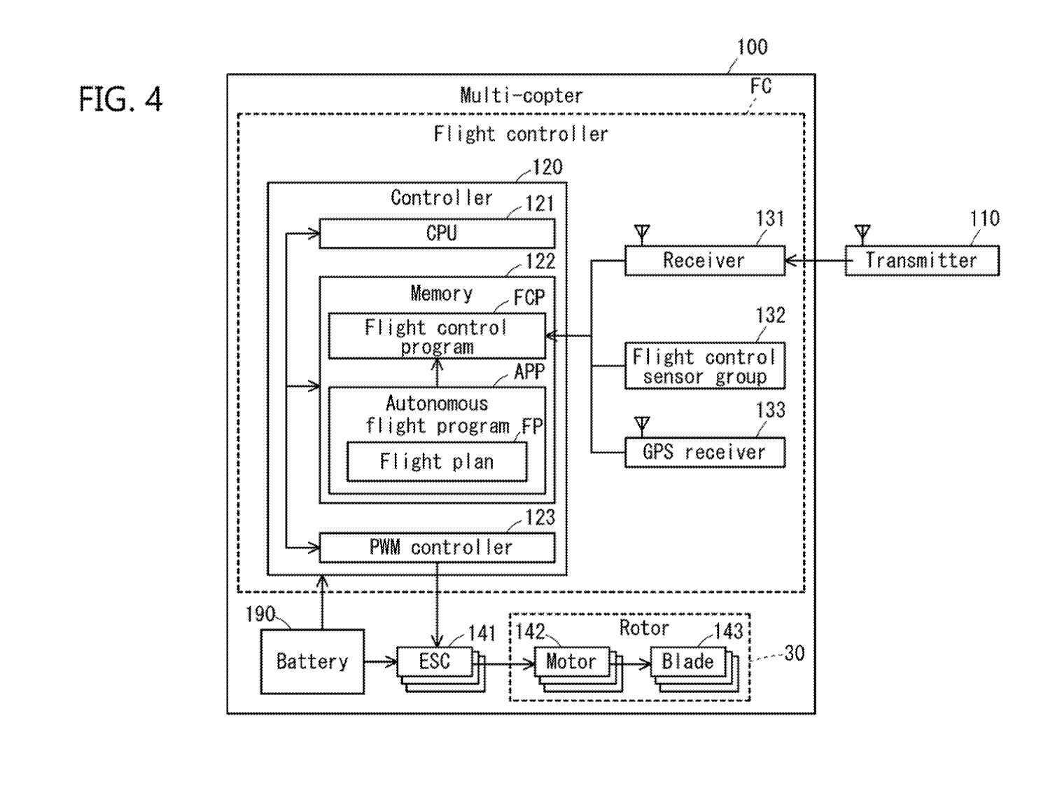

The configuration of the multi-copter 100 is similar to the configuration of a known multi-copter, except the configuration of the each float 40. FIG. 4 is a block diagram illustrating a functional configuration of the multi-copter 100. The airframe of the multi-copter 100 mainly includes: a flight controller FC; six rotors 30; ESCs 141 (Electric Speed Controllers), which control rotation of the respective rotors 30; and a battery 190, which supplies power to the foregoing elements.

Each rotor 30 of the rotors 30 includes: a motor 142; and a blade 143, which is connected to the output shaft of the motor 142. Each ESC 141 of the ESCs 141 is connected to the motor 142 of the rotor R and causes the motor 142 to rotate at a speed specified by the flight controller FC.

It is to be noted that there is no particular limitation to the number of rotors of the multi-copter 100; the number of rotors may be determined considering required flight stability, cost tolerated, and other considerations. As necessary, the multi-copter may be changed to: a tricopter, which has three rotors R; an octocopter, which has eight rotors R; and even a multi-copter having more than eight rotors.

The flight controller FC includes a controller 120, which is a micro-controller. The controller 120 includes: a CPU 121, which is a central processing unit; a memory 122, which is a storage device such as ROM and RAM; and a PWM (Pulse Width Modulation) controller 123, which controls the number of rotations of the motor 142 and the rotational speed of the motor 142 through the each ESC 141.

The flight controller FC further includes a flight control sensor group 132 and a GPS receiver 133 (these will be hereinafter occasionally referred to as “sensors”). The flight control sensor group 132 and the GPS receiver 133 are connected to the controller 120. The flight control sensor group 132 of the multi-copter 100 according to this embodiment includes a three-axis acceleration sensor, a three-axis angular velocity sensor, a pneumatic sensor (altitude sensor), and a geomagnetic sensor (direction sensor).

The controller 120 is capable of obtaining, from these sensors, how much the airframe is inclined or rotating, latitude and longitude of the airframe on flight, altitude, and position information of the airframe including nose azimuth.

The memory 122 of the controller 120 stores a flight control program FCP, in which an algorithm for controlling the posture of the multi-copter 100 during flight and controlling basic flight operations is described. In response to an instruction from an operator (transmitter 110), the flight control program FCP adjusts the number of rotations of each rotor R based on information obtained from the sensors so as to correct the posture and/or position of the airframe while the multi-copter 100 is making a flight.

The multi-copter 100 may be manipulated manually by the operator using the transmitter 110. Another possible example is to: register a flight plan FP in an autonomous flight program APP in advance, the flight plan FP being a parameter such as the flight path, speed, or altitude of the multi-copter 100; and cause the multi-copter 100 to fly autonomously to the destination (this kind of autonomous flight will be hereinafter referred to as “autopilot”).

Thus, the multi-copter 100 according to this embodiment has high-level flight control functions. However, the unmanned aerial vehicle according to the present invention may be any other airframe that includes a plurality of rotors R and that controls the posture of the airframe and the flight operation of the airframe by adjusting the number of rotations of the rotor R. Other examples include: an airframe in which one or some of the sensors is omitted; and an airframe that is without an autopilot function and that is capable of flying by manual manipulation only.

While the embodiment of the present invention has been described hereinbefore, the present invention will not be limited to the above-described embodiment; various modifications are possible without departing from the scope of the present invention. For example, while the floats 40 according to the above embodiment are located at the leading ends of the respective arms 20, the floating portions according to the present invention may be located at portions other than the leading ends of the arms. Also, the rotors 30 may not necessarily be located above the respective floats 40. Further, the floating portions according to the present invention may not necessarily have tapering shapes in all applications insofar as the floating portions extend downward from the respective arms.

1. An unmanned aerial vehicle comprising:
a plurality of rotary wings; and
a plurality of arms radially extending from an airframe center portion of the unmanned aerial vehicle,
wherein the arms comprise floating portions extending downward from the respective arms, and
wherein the floating portions comprise air chambers in the respective floating portions, the air chambers each comprising a hollow and hermetic space.

2. The unmanned aerial vehicle according to claim 1, wherein each floating portion of the floating portions has a tapering shape having an outer diameter that gradually decreases toward a lower end of the each floating portion.

3. The unmanned aerial vehicle according to claim 2, wherein the each floating portion has an vertically long shape, and the each floating portion has the tapering shape at a lower side in a vertical direction of the each floating portion.

4. The unmanned aerial vehicle according to claim 1,
wherein the floating portions are located at leadings end of the respective arms, which comprise the respective floating portions, and
wherein the rotary wings are located above the respective floating portions.

5. The unmanned aerial vehicle according to claim 1,
wherein each air chamber of the air chambers of the floating portions comprises an air valve, and
wherein the air valve is configured to keep pressure in the each air chamber within a predetermined range by: releasing air out of the each air chamber when the pressure in the each air chamber has increased and exceeded a predetermined threshold; and taking the air into the each air chamber when the pressure in the each air chamber has decreased and fallen below a predetermined threshold.

6. The unmanned aerial vehicle according to claim 1,
wherein each floating portion of the floating portions further comprises a leg storage chamber that comprises a space vertically extending along a center in a radial direction of the each floating portion,
wherein the leg storage chamber is partitioned from the air chamber and extends downward through the each floating portion,
wherein the leg storage chamber contains an elastic member and a bar-shaped member energized downward by the elastic member, and
wherein the bar-shaped member has a lower end portion exposed downward through the leg storage chamber.

7. The unmanned aerial vehicle according to claim 1, wherein the plurality of arms comprise three or more arms circumferentially arranged at equal intervals around the airframe center portion.
